(19) United States
(12) Patent Application Publication
(10) Pub. No.: US 2017/0124281 A1
(43) Pub. Date: May 4, 2017

(54) Systems and Methods for Analyzing Medication Adherence Patterns

(71) Applicant: Cerner Innovation, Inc., Kansas City, KS (US)

(72) Inventors: Cole Anthony Erdmann, Kansas City, MO (US); Darcy A. Davis, Elmhurst, IL (US); Amanda Kathleen Sullins, Lee's Summit, MO (US); Justin J. Kimbrell, Leawood, KS (US); Bharat B. Sutariya, Parkville, MO (US)

(21) Appl. No.: 14/926,664

(22) Filed: Oct. 29, 2015

(51) Int. Cl. G06F 19/00

(52) U.S. Cl. CPC G06F 19/3456; G06F 19/326; G06F 19/322; G06F 19/3487

(57) ABSTRACT

The present invention relates to methods, systems, and computer-readable media for tracking prescription refills and determining medication adherence patterns for a patient. Information about a patient's prescriptions is gathered and analyzed to determine patterns of medication adherence for the patient. These patterns may be used to identify whether the patient is at risk for non-adherence and to identify potential barriers to adherence for the patient. The system may also generate recommended clinical interventions to address instances of non-adherence.

### BACKGROUND

Medication non-adherence is one of the most expensive problems in healthcare. Nearly 300 billion of the $750 billion the United States spends annually on healthcare could be avoided with improved medication adherence which equates to around $2,000 per patient. Moreover, medication non-adherence causes 30-50% of treatment failures and results in 125,000 deaths annually. It has been determined that medication adherence is the number one thing that patients lie to their doctors about. Out of every 100 prescriptions written, 50-70% are filled, 48-66% are picked up, 25-30% are taken as directed, and only 15-20% are refilled as prescribed.

Medication non-adherence is a multi-faceted problem. The majority of solutions have focused on the most common reason for non-adherence—forgetfulness. However, this only accounts for about 25% of non-adherence. Other commonly reported risk factors for non-adherence include side effects of the medication, cost of the medication, the patient's impression that the medication is not necessary, and/or the inability of the patient to obtain transportation to access a pharmacy.

There is a need for a system that will enhance communication between venues of care, decrease the risk of medication reconciliation errors, and provide the clinician with an accurate picture of which medications the patient is filling in an outpatient setting. There is a need for a system that can recognize patterns of medication non-adherence in order to provide interventions to improve medication adherence and prevent adverse events from occurring.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for tracking prescription fills and determining medication adherence patterns for patients. As previously mentioned, patients often fail to fill and use their prescription medications as prescribed. By tracking a patient's medication fill history, a physician can determine whether a patient is taking medications as directed. If the patient is not adhering to prescribed instructions for taking medications, a physician can determine if the patient's non-adherence puts the patient at risk for additional health problems. Barriers to adherence can be determined and interventions can be applied to address those barriers. Tracking a patient's medication adherence can prevent adverse health events from occurring due to non-adherence.

In one embodiment, computer-storage media having computer-executable instructions embodied thereon that when executed, performs a method of tracking medication adherence is provided. A selection of a patient is received. Data sources are queried to find prescription data for the patient. The prescription data is extracted from the data sources and compiled into a medication refill history for the patient. The medication refill history is then analyzed to determine medication adherence patterns for the patient. Finally, a medication adherence graphic is automatically generated to represent the medication adherence patterns for the patient.

In another embodiment, a computerized method is carried out by at least one server having at least one processor for determining medication adherence patterns for a patient. A patient is selected then medication information related to the patient is retrieved from various sources. A prescription order and refill history is assembled based on the medical information and a level of medication adherence for the patient is determined by analyzing the prescription refill history. The prescription refill history is then displayed, indicating patterns of medication adherence for the patient. The patterns of medication adherence are analyzed to identify barriers to adherence and then clinical interventions are recommended to address those barriers.

In yet another embodiment, a computer-implemented system is designed to track medication adherence. A computer having at least one processor performs a number of steps beginning with receiving a selection of a patient. Medication data for the patient is then extracted from prescription data sources. A prescription refill history is constructed for the patient. The percentage of days covered for each medication prescribed is calculated, as is a medication adherence score for the patient. A base adherence pattern label and one or more add-on adherence pattern labels are assigned to the patients and the patient's medications. The patient's medication adherence patterns are then displayed and analyzed to identify barriers to medication adherence. Finally, intervention strategies are automatically generated to address the barriers to medication adherence.

### BRIEF DESCRIPTION OF THE DRAWINGS

Embodiments are described in detail below with reference to the attached drawings figures, wherein:

FIG. 1 is a block diagram of an exemplary computing system suitable to implement embodiments of the present invention;

FIG. 2 is a block diagram of an exemplary computing system for tracking medication adherence patterns of a patient, in accordance with an embodiment of the present invention;

FIG. 3 is an exemplary display of medication adherence patterns for a patient, in accordance with an embodiment of the present invention;

FIGS. 4A-4D illustrate examples of medication adherence patterns for different patients, in accordance with an embodiment of the present invention;

FIG. 5 depicts an exemplary graphical user interface for displaying a medical refill history and medication adherence patterns for a patient, in accordance with an embodiment of the present invention;

FIG. 6 is a flow diagram that illustrates an exemplary method of tracking medication adherence, in accordance with an embodiment of the present invention; and

FIG. 7 is a flow diagram that illustrates an exemplary method of determining medication adherence patterns for a patient, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for determining and tracking medication adherence patterns for a patient. Medication adherence refers to whether a patient is taking medications correctly as prescribed. As previously mentioned, lack of medication adherence is a serious problem within the healthcare industry. While clinicians may not be able to monitor a patient's daily intake of medications, they are able to use the present invention to access patient information regarding fills and refills of the patient's prescriptions. These records provide an indication of the patient's adherence levels by comparing actual prescription fills and refills with what is prescribed by a clinician and presenting adherence patterns to the clinician in an easy to read visual format.

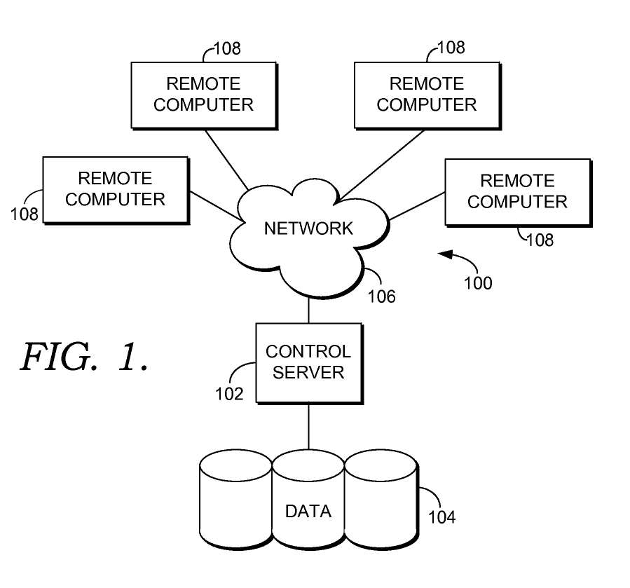

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, pharmacies, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

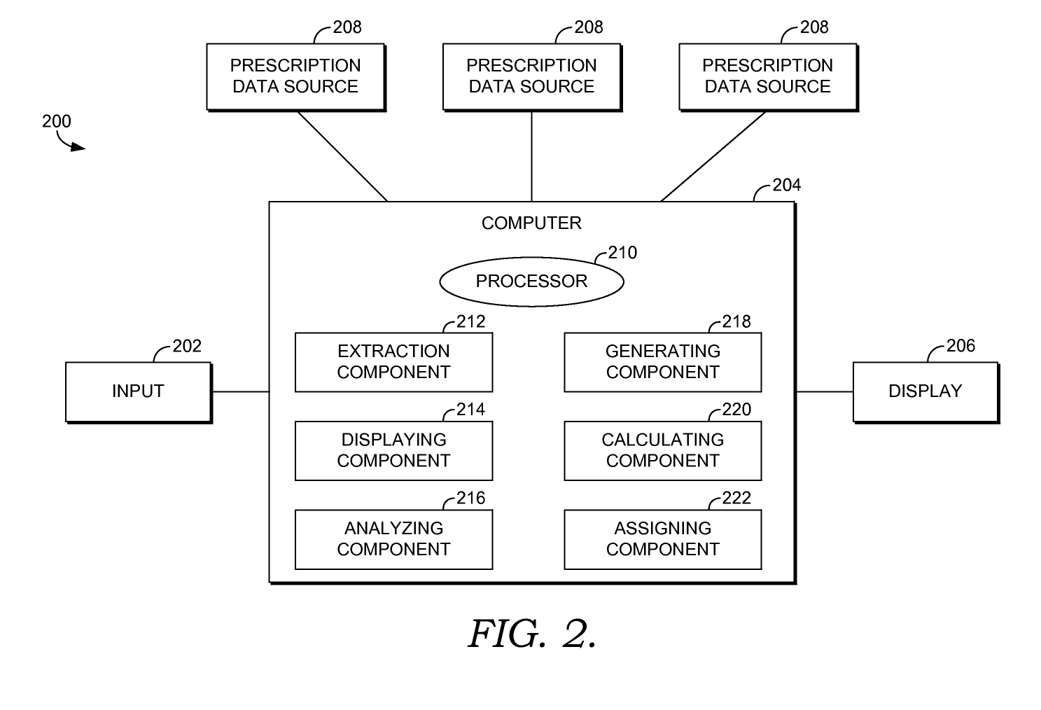

Turning now to FIG. 2, an exemplary computing system 200 is depicted. The computing system 200 is merely an example of one suitable computing system and is not intended to suggest any limitation as to the scope of use or functionality of embodiments of the present invention. Neither should the computing system 200 be interpreted as having any dependency or requirement related to any single module/component or combination of modules/components illustrated therein.

The computing system 200 includes a processor 210, an extraction component 212, a displaying component 214, an analyzing component 216, a generating component 218, a calculating component 220, and an assigning component 222 within a medication adherence pattern service 204. The computing system 200 may also include one or more end-user display devices 206 useable to view the information provided by the medication adherence pattern service 204 and an input device 202 to receive selections and/or inputs from a user. The medication adherence pattern service 204 receives information from one or more prescription data sources 208.

In some embodiments, one or more of the illustrated components/modules may be implemented as stand-alone applications. In other embodiments, one or more of the illustrated components/modules may be integrated directly into the operating system of the medication adherence pattern service. The components/modules described are exemplary in nature and in number and should not be construed as limiting. Any number of components/modules may be employed to achieve the desired functionality within the scope of embodiments hereof. Further, components/modules may be located on any number of servers.

The input device 202 functions to receive inputs from a user. The input device 202 may be a keyboard, a microphone, a touch screen, a mouse, a trackball, or a touch pad. The input device 202 is used by a user to select a patient in order to see that patient's medication information. The processor 210 within the medication adherence pattern service 204 receives the selection of the patient.

In response to the selection of a patient, the extraction component 212 is configured to extract medication or prescription data from various prescription data sources 208. The prescription data sources 208 may include electronic medical records, outpatient pharmacy records, long-term care facility records, e-prescriptions, insurance claims, prescription benefit manager records, and the like. The medication data may include drug names, strength of prescriptions, dosages, routes of administration, fill dates, and/or days' supply of each drug.

The generating component 218 is configured to use the medication information extracted from the prescription data sources 208 to construct or generate a prescription refill history for the selected patient. The prescription order and refill history includes timelines representing prescription fill events for each medication the patient is prescribed. The prescription refill history may be updated in real time in response to udpates in the patient's prescription information.

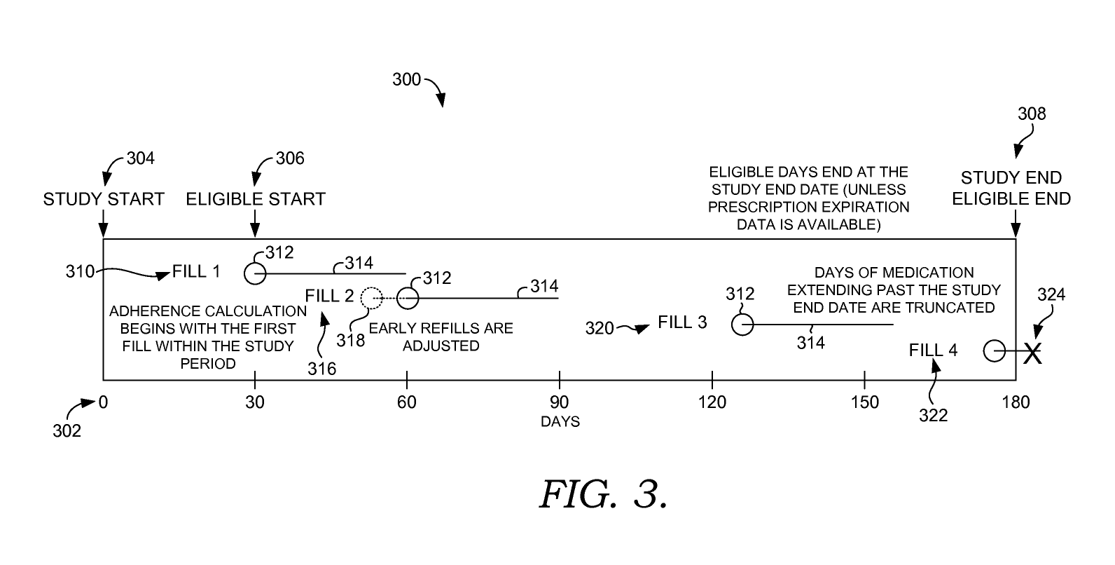

FIG. 3 depicts an exemplary display 300 of a patient's prescription refill history for one medication. This particular display shows medication refills for a patient as part of a study of medication adherence. A timeline 302 is provided in days at the bottom of the display 300. The timeline runs from the study start 304, through the eligible start 306 and ends at the study end and eligible end 308. The study start 304 and end 308 date refer to the time period in which the patient's medication refills are examined. The eligible start date 306 is when the patient may first fill a prescription. Here, the eligible end date 308 is the same as the study end date 308 because the prescription could continue on. However, if the prescription had a limited duration, the eligible end date may be before the study end date.

Each time the patient fills a prescription, the fill or refill event is depicted with a solid circle 312. For example, for “FILL 1” 310, the fill occurs on day 30. Each circle is followed by a line 314 extending laterally from the circle in the direction of the timeline 302. For “FILL 1” 310, the line 314 extends until day 60. This line 314 represents the duration of the prescription. This particular medication has a duration of 30 days.

“FILL 2” 316 shows a dotted circle 318, which represents when a refill was filled early. Here, the medication was filled a few days before the next date that the patient would need additional medication. The fill date is then adjusted on the chart to show a solid circle 312 at day 60, indicating the time at which the patient would begin taking the medication from that refill.

There is a gap between “FILL 2” 316 and “FILL 3” 320, indicating that the patient was not taking the medication during that time because the patient did not refill the medication again until after day 120. Another gap in time is shown between “FILL 3” 320 and “FILL 4” 322.

“FILL 4” 322 has a truncated line ending in an “X” 324 to indicate that the amount in the prescription would have lasted longer than the end of the study. The overall display 300 of the patient's prescription refill history provides information that can be used to analyze the patient's medication adherence patterns.

A patient's prescription refill history may be represented in a number of ways. The display of FIG. 3 is merely an example. The duration of prescriptions may be represented by other visual indicators such as colored bars, lines with hash marks indicating the start and end of the prescription, arrows, and the like. Similarly, the timeline of the prescription refill history may be represented in different ways. The timeline could be arranged horizontally, vertically, on a calendar, and the like.

Returning to FIG. 2, the prescription refill history is used by the calculating component 220 to calculate the percentage of days covered (PDC) for each medication the patient is prescribed. The PDC is calculated by dividing the number of days covered by the number of eligible days for each medication. The calculating component 220 is also configured to calculate a medication adherence score for the patient based on the PDCs of the medications the patient is prescribed. The medication adherence score indicates an overall rating of the patient's medication adherence. Medication adherence patterns are determined and automatically displayed in a medication adherence graphic.

The assigning component 222 is configured to assign a base adherence pattern label to the patient. The base adherence pattern labels may be “High,” “Moderate,” “Low,” or “Mixed” depending on the patient's medication adherence score. The assigning component 222 also assigns one or more add-on adherence pattern labels to each of the medications the patient is prescribed. The add-on adherence pattern labels include outlier, end gap, sync gap, and overpossession. The add-on adherence pattern labels may indicate to a clinician that the patient is at risk for medication non-adherence.

The generating component 218 is configured to then generate a display of the patient's medication adherence patterns in the form of a patient medication graphic. A patient medication graphic may include a list of under-utilized medications, a list of over-utilized medications, an overall adherence rating for the patient, a percentage of days covered table for eligible medications, a percentage of days covered table for adherence by disease state, a list of potential and/or previous recognized barriers to adherence for the patient, and a list of intervention strategies for the patient. The patient medication graphic may display the medications prescribed to the patient in groups organized by class of medication.

The analyzing component 216 analyzes the patient's medication adherence patterns and the patient's electronic medical record (EMR) to identify barriers to medication adherence for patients at risk for non-adherence. Barriers to adherence may include, for example, language barriers, forgetting to refill prescriptions, cost of medication, side effects of medication, and lack of transportation to a pharmacy. Based on the identified barriers, then the generating component 218 automatically generates one or more intervention strategies to address the barriers to medication adherence. These intervention strategies may be displayed in the medication adherence graphic. A clinician may view the medication adherence patterns, barriers to adherence, and recommended intervention strategies to formulate a course of treatment for the patient in order to address known or potential medication non-adherence.

The displays generated by the computer 204 are displayed on a display device 206. The end-user computing device may include a display screen. Embodiments are not intended to be limited to visual display but rather may also include audio presentation, combined audio/visual presentation, and the like. The end-user computing device may be any type of display device suitable for presenting a graphical user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions. Interaction with the graphical user interface may be via a touch pad, a microphone, a pointing device, and/or gestures.

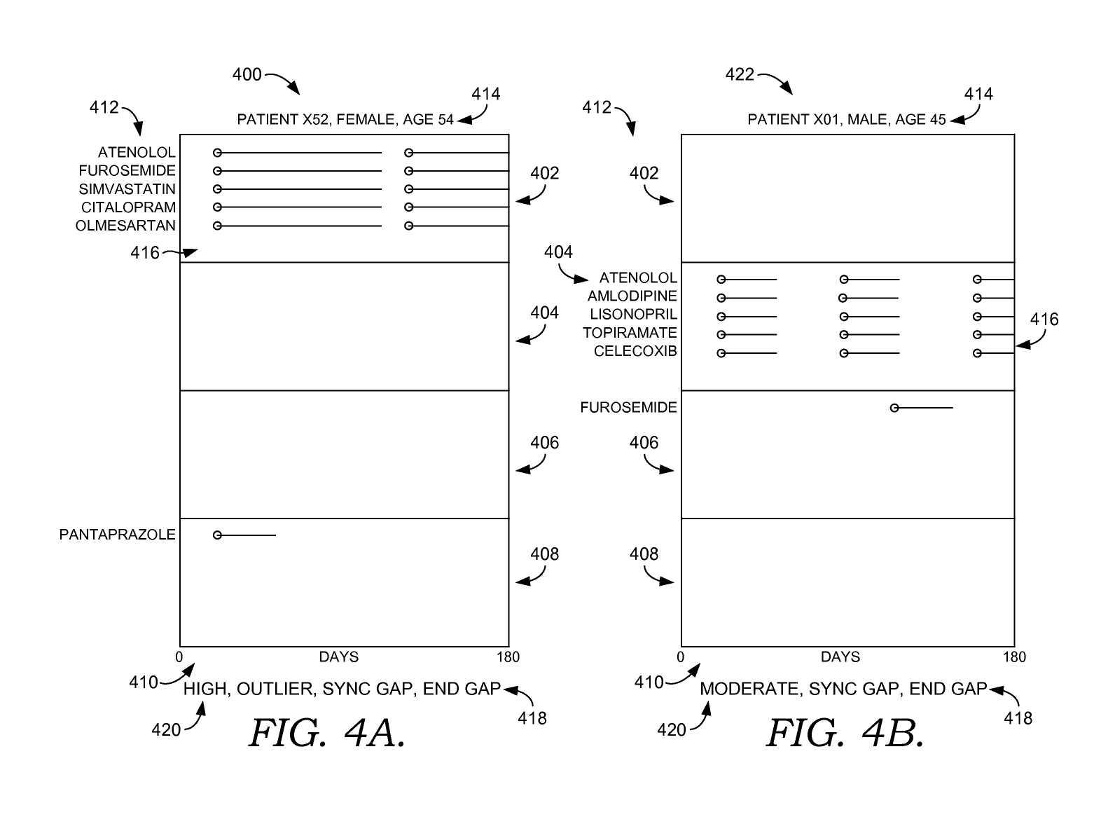

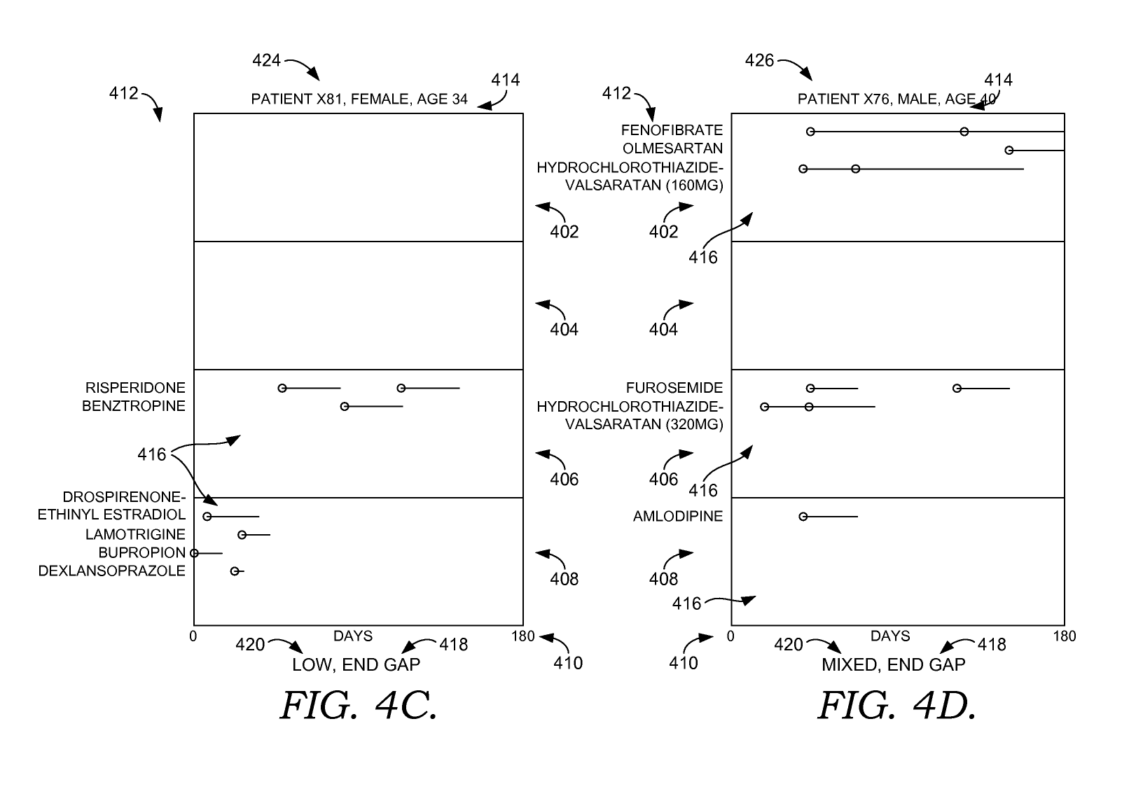

FIGS. 4A-4D illustrate examples of a medication adherence graphics 400, 422, 424, 426 for a patient. Here, the display of medications which the patient has been prescribed are arranged into quarters by percentage of days covered (PDC). The PDC is calculated as the proportion of days in a time interval that are covered by a prescription. In equation form, the PDC=days covered/eligible days. The PDC may be calculated by a calculating component, such as the calculating component 220 of FIG. 2. For example, if there are 150 days in the time interval and the patient has a prescription that covers 95 days, the PDC is 0.63. Quarter 1 (Q1) 408 includes medications for which the patient's PDC is 0-25%, Quarter 2 (Q2) 406 includes medications with a PDC of 25-50%, Quarter 3 (Q3) 404 has a PDC of 50-75%, and Quarter 4 (Q4) 402 includes all medications for which the PDC for that patient is 75-100%.

In the first example medication adherence graphic 400 of FIG. 4A, the patient description 414 shows that the patient is a 54 year old female. There are six medications 412 listed on this patient's medication adherence graphic 400. Five of the medications 412 are located within Q1 402, indicating that the PDC for all of the medications is at least 75%. One medication (Pantaprazole) is located within Q4 408, indicating a PDC of 25% or less. Next to each medication is a graphic representing when and how often each medication was filled at a pharmacy.

A timeline 410 in days is presented at the bottom of the graphic 400. As was described above with respect to FIG. 3, each fill event is represented by a circle and the duration of the prescription is represented by a line extending laterally from the circle. The overall pattern of adherence 416 is displayed in the collection of circles and lines. From this medication adherence graphic 416, a physician could easily tell that this patient is generally filling and taking the medications as prescribed, with the exception of Pantaprazole.

The medication adherence graphic 400 is labeled with a base adherence pattern label 420 and three add-on adherence pattern labels 418. The pattern labels are assigned to the medication adherence graphic 400 by an assigning component, such as the assigning component 222 of FIG. 2. The base adherence pattern label 420 for this patient indicates that, overall, the patient has high adherence. High adherence occurs when at least 75% of the patient's medications lie within Q4. The add-on adherence pattern labels 418 describe various aspects of the adherence patterns 416. For this example, there is an outlier, a sync gap, and an end gap.

An outlier is any drug that falls within a PDC range two or more quarters away from the patient's base adherence pattern label 420. Because Pantaprazole is in Q1 408 and the patient's base adherence pattern label 420 is “High,” the “outlier” add-on adherence pattern label 418 applies.

A “sync gap” add-on adherence pattern label 418 applies whenever there are three or more medications prescribed to a patient that are filled with synchronized gaps. Here, Atenolol, Furosemide, Simvastatin, Citalopram, and Olmesartan were all refilled a few days after the supply of the first fill ran out. This is indicated with a space between the lines and the next circle on the timeline. The spaces occur all at the same time, indicating that this pattern is patient-specific, rather than medication specific.

An “end gap” add-on adherence pattern label 418 applies whenever there is no coverage for a medication within 30 days of the end date. In short, this add-on adherence pattern label 418 indicates that the patient has discontinued use of a drug prematurely.

An “overpossession” add-on adherence pattern label (not shown) applies when a patient has possession of more of a medication than has been prescribed.

The example in FIG. 4B shows a second medication adherence graphic 422 with a patient description 414 indicating that the adherence patterns 416 are for a 45 year old male. This patient is given the base adherence pattern label 420 of “Moderate.” The “moderate” base adherence pattern label 420 applies when 75% of a patient's prescriptions fall within Q3 404. Here, five of the six medications 412 listed are located within Q3 404. Furosemide is located within Q2 404, but it is not considered an “outlier” because it is within one quarter of the patient's base adherence pattern label 420.

The add-on adherence pattern labels 418 “sync gap” and “end gap” have been assigned to this patient's medications. The “sync gap” add-on adherence pattern label 418 applies to Atenolol, Amlodiprine, Lisonopril, Topiramate, and Celecoxib in Q3 404. As with the medications in FIG. 4A, these medications are all refilled, but there is an extended period of time between the end of the first fill and the start of the second fill such that the patient presumably does not have medication coverage for that period of time. The “end gap” add-on adherence pattern label 418 applies to Furosemide because the patient discontinued use of the medication for at least 30 days.

A third exemplary medication adherence graphic 424 is shown in FIG. 4C. The patient identification information 414 indicates that this medication adherence pattern 416 is for a 34 year old woman. This medication adherence graphic 424 has been assigned the base adherence pattern label 420 of “Low” and the add-on adherence pattern label 418 of “end gap.” The “Low” base adherence pattern label 420 applies because 75% or more of this patient's prescriptions 412 are found in Q1 408 and Q2 406. This medication adherence pattern 416 has also been assigned the add-on adherence pattern label 418 of “end gap” which applies to all of the medications 412 prescribed to this patient.

FIG. 4D depicts a fourth exemplary medication adherence graphic 426 for a patient having the patient identification information 414 of “male, age 40.” This medication adherence pattern 416 has been assigned a base adherence pattern label 420 of “mixed.” This base adherence pattern label 420 applies to any patient that does not fit into the categories of “high,” “moderate,” or “low.” As can been seen in the medication adherence pattern 426 for this patient, three medications are in Q4 402, two medications are in Q2 406, and one medication is in Q1, 408. The patient's patterns of refills for these medications 412 are irregular. The “end gap” add-on adherence pattern label 418 applies to many of these medications 412.

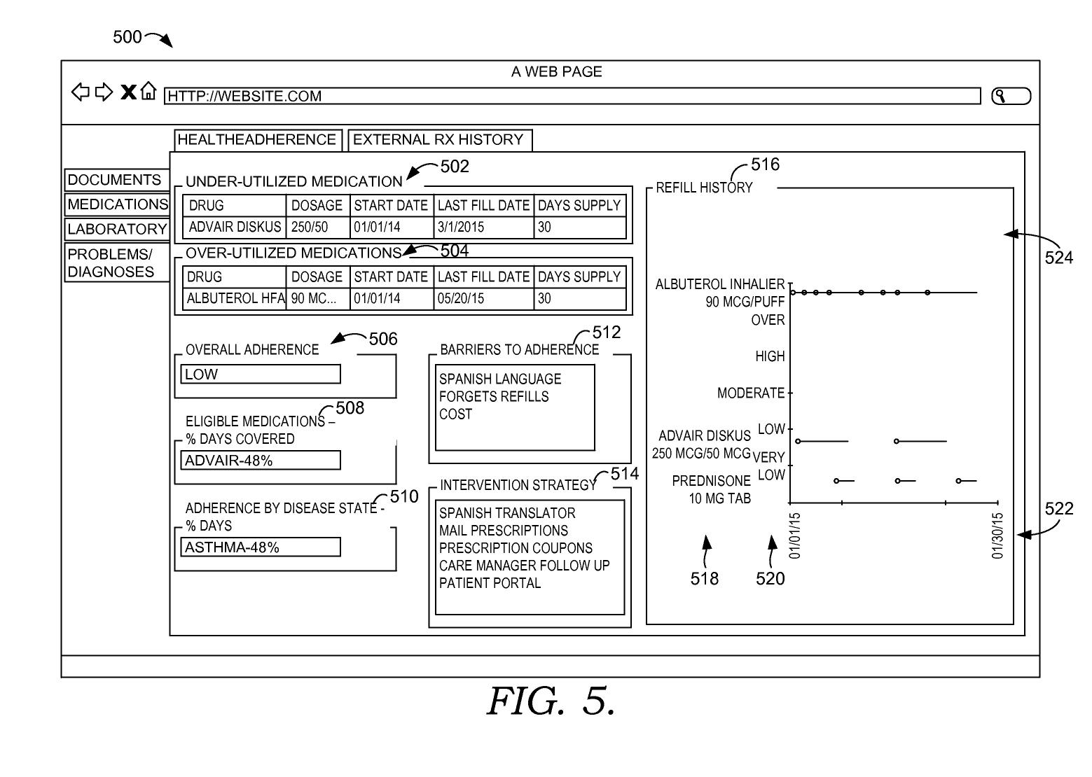

FIG. 5 depicts an exemplary graphical user interface (GUI) 500 for displaying a patient's medication adherence patterns. The GUI 500 includes a list of under-utilized medications 502 and over-utilized medications 504. The GUI 500 may also include an overall medication adherence score 506 for the patient. A list of eligible medications and the percentage of days covered 508 along with the percentage of days for adherence by disease state 510 may also be displayed. Barriers to adherence 512 and intervention strategies 514 are also displayed. The patient's prescription refill history 516 including a list of medications 518, levels of adherence 520, a timeline 522, and medication adherence patterns 524 is included in the GUI 500. The GUI displays the patient's medication information in a way that enables a clinician or physician to quickly determine whether the patient is at risk for medication non-adherence and whether interventions are necessary.

The list of under-utilized medications 502 is included to highlight medications that the patient is prescribed which the patient has not filled often enough. Conversely, the list of over-utilized medications 504 is included to highlight medications that the patient is filling too often, resulting in the patient having a greater supply than is prescribed. By highlighting these medications, a physician can quickly identify the medications that are not being taken properly by the patient and determine if interventional measures are necessary.

The overall medication adherence score 506 is based on the PDC for each medication the patient is prescribed. The overall medication adherence score 506 may be calculated by a calculating component, such as the calculating component 220 of FIG. 2. In the exemplary GUI 500 of FIG. 5, the patient has an overall medication adherence score 506 of “LOW.” As described above, this label applies when 75% of the patient's medications fall within Q1 or Q2.

The eligible medications PDC 508 shows the percentage of days covered for a particular medication. In the example of FIG. 5, the patient has only taken Advair 48% of the days for which the prescription should be covered. Similarly, the adherence by disease state FIG. 510 indicates the percentage of days covered for medications relating to a particular disease state. In FIG. 5, the patient adheres to prescriptions 48% of the eligible days for asthma medications.

The display of barriers to adherence 512 may include a list of reasons that a patient is not taking prescribed medications properly. This list may include barriers that are known to the physician or potential barriers identified by the patterns of the patient's medication adherence. In addition, a display of intervention strategies 514 may be provided. The intervention strategies are automatically generated in response to the list of barriers to adherence. The intervention strategies may be generated by a generating component, such as the generating component 218 of FIG. 2.

The GUI 500 also includes a display of the patient's refill history 516. This includes a list of the medications 518 prescribed to the patient. These medications may be displayed in order of level of adherence 520. Medication adherence patterns 524 for the patient are displayed in reference to a timeline 522. The medication adherence patterns 524 may be the same or similar to those described in FIG. 3 and FIGS. 4A-4D.

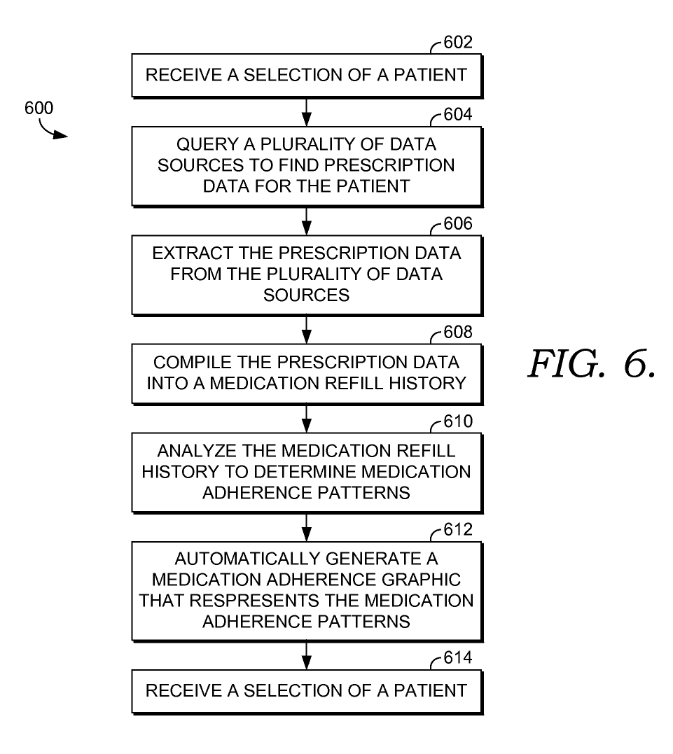

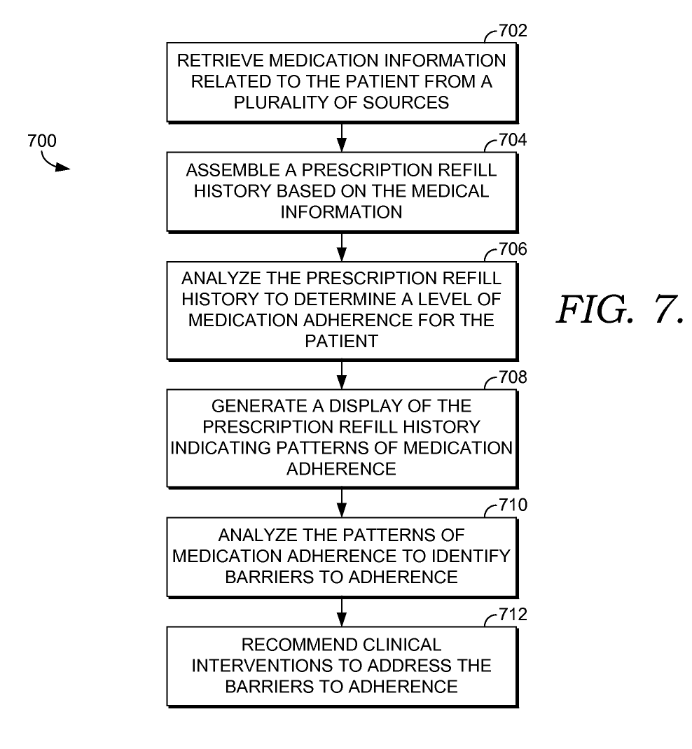

FIG. 6 depicts a flow diagram of an exemplary method 600 of tracking medication adherence. At a step 602, a selection of a patient is received. The selection of the patient may be made with an input device, such as the input device 202 of FIG. 2. A plurality of data sources are then queried to find prescription data for the selected patient in a step 604. The data sources may be prescription data sources, such as the prescription data sources 208 of FIG. 2. At a step 606 the prescription data is extracted from the plurality of data sources.

The prescription data is then compiled into a medication refill history at a step 608. The medication refill history may be generated with a generating component, such as generating component 218 of FIG. 2. At a step 610, the medication refill history of the patient is analyzed to determine one or more medication adherence patterns for the patient. The medication refill history may be analyzed by an analyzing component, such as the analyzing component 216 of FIG. 2.

The analysis of the patient's medication refill history may indicate that a patient has not refilled a prescription. If the patient fails to fill or refill a prescription within a set period of time, an alert may be communicated to a clinician. For example, an alert may be sent to a physician if a patient has not refilled a prescription within 10 days of the previous prescription running out.

A medication adherence graphic representing the medication adherence patterns for the patient is automatically generated at a step 612. The medication adherence graphic may be generated by a generating component, such as the generating component 218 of FIG. 2. The medication adherence graphic may then be displayed on a display device, such as the display device 206 of FIG. 2.

FIG. 7 depicts a flow diagram of an exemplary method 700 of determining medication adherence patterns for a patient, which may be carried out by a computer, such as the computer 204 of FIG. 2. At a step 702, a selection of a patient is received. The selection of the patient may be made with an input device, such as the input device 202 of FIG. 2. At a step 704, medication information related to the patient is retrieved from a plurality of sources. The sources may be prescription data sources, such as the prescription data sources 208 of FIG. 2. The medication information may be retrieved using an extraction component, such as the extraction component 212 of FIG. 2.

A prescription refill history based on the patient's medical information is assembled at a step 706. The prescription refill history may be assembled with a generating component, such as generating component 218 of FIG. 2. At a step 708 the prescription refill history is analyzed to determine a level of medication adherence for the patient. The prescription refill history may be analyzed by an analyzing component, such as the analyzing component 216 of FIG. 2.

At a step 710 a display of the prescription refill history is generated, indicating one or more patterns of medication adherence for the patient. The display of the prescription refill history may be generated by a generating component, such as the generating component 218 of FIG. 2. The display of the prescription refill history may be displayed on a display device, such as the display device 206 of FIG. 2.

The patterns of medication adherence are analyzed to identify barriers to adherence at a step 712. The patterns of medication adherence may be analyzed by an analyzing component, such as the analyzing component 216 of FIG. 2. At a step 714, interventions are recommended to address the barriers to adherence based on the patient's specific needs. The clinical interventions may be recommended by a generating component, such as the generating component 218 of FIG. 2. The interventions may also be displayed on a display device, such as the display device 206 of FIG. 2.

An alert may be generated when the patient's medication adherence patterns indicate that the patient has failed to fill a prescription within a set period of time. This alert is communicated to a clinician. The clinician may then employ clinical interventions to ensure that the patient is properly taking medications as prescribed.

The present invention has been described in relation to particular embodiments, which are intended in all respects to be illustrative rather than restrictive. Further, the present invention is not limited to these embodiments, but variations and modifications may be made without departing from the scope of the present invention.

1. One or more computer-storage media having computer-executable instructions embodied thereon that, when executed by a computing device, perform a method of tracking medication adherence, the method comprising:
receiving a selection of a patient;
querying a plurality of data sources to find prescription data for the patient;
extracting the prescription data from the plurality of data sources;
compiling the prescription data into a medication order and refill history for the patient;
analyzing the medication refill history to determine one or more medication adherence patterns for the patient; and
automatically generating a medication adherence graphic that graphically represents the one or more medication adherence patterns for the patient.

2. The media of claim 1, wherein the plurality of data sources include one or more of the patient's electronic medical records, outpatient pharmacy records, long-term care facility records, e-prescriptions, insurance claims, and prescription benefit manager records.

3. The media of claim 1, wherein the medication data includes one or more of drug names, strength of prescriptions, dosages, route of administration, fill dates, and days' supply of each drug.

4. The media of claim 1, further comprising utilizing the one or more medication adherence patterns to determine a set of base labels for the patient, the base labels comprising one of high, moderate, low, or mixed adherence.

5. The media of claim 1, further comprising utilizing the one or more medication adherence patterns to determine a set of add-on labels for the patient, the add-on labels comprising one or more of outlier, sync gap, end gap, and overpossession.

6. The media of claim 4, wherein the medication adherence graphic comprises one or more of a list of under-utilized medications, a list of over-utilized medications, an overall adherence rating for the patient, a percentage of days covered table for eligible medications, a percentage of days covered table for adherence by disease state, a list of barriers to adherence for the patient, and a list of intervention strategies for the patient.

7. The media of claim 1, further comprising automatically generating one or more clinical interventions when the patient's one or more medication adherence patterns indicate that the patient is at risk for non-adherence.

8. The media of claim 1, further comprising:
automatically generating an alert when the patient's one or more medication adherence patterns indicate that the patient has failed to fill a prescription within a set period of time; and
communicating the alert to a clinician.

9. A computerized method carried out by at least one server having at least one processor for determining medication adherence patterns for a patient, the method comprising:
receiving a selection of a patient;
retrieving medication information related to the patient from a plurality of sources;
assembling a prescription order and refill history based on the medical information;
analyzing the prescription order and refill history to determine a level of medication adherence for the patient;
generating a medication adherence graphic indicating one or more patterns of medication adherence for the patient;
analyzing the one or more patterns of medication adherence to identify barriers to adherence; and
recommending clinical interventions to address the barriers to adherence.

10. The method of claim 9, wherein the barriers to adherence are one or more of language barrier, forgetting to refill prescriptions, cost of medication, side effects of medication, and lack of transportation to a pharmacy.

11. The method of claim 9, wherein the display of the prescription refill history comprises one or more timelines representing prescription fill events, wherein each timeline represents a drug the patient is prescribed.

12. The method of claim 11, wherein the one or more timelines comprise one or more circles representing fill events and one or more lines following the one or more circles representing the duration of the prescription.

13. The method of claim 10, wherein the prescription order and refill history is updated in real time.

14. A system for tracking medication adherence, the system comprising:
a computer having at least one processor, wherein the computer performs the following steps:
receiving a selection of a patient;
extracting medication data for the patient from a plurality of prescription data sources;
constructing a prescription refill history for the patient;
calculating the percentage of days covered for each medication the patient is prescribed;
calculating a medication adherence score for the patient;
assigning a base adherence pattern label to the patient;
assigning one or more add-on adherence pattern labels to one or more of the medications the patient is prescribed;
generating a display of the patient's medication adherence patterns;
analyzing the patient's medication adherence patterns to identify barriers to medication adherence; and
automatically generating intervention strategies to address the barriers to medication adherence.

15. The system of claim 14, further comprising alerting a clinician if the patient has not filled a prescription within a defined amount of time.

16. The system of claim 14, wherein the base adherence pattern label is one of high, moderate, low, and mixed.

17. The system of claim 14, wherein the add-on adherence pattern labels are one or more of outlier, sync gap, end gap, and overpossession.

18. The system of claim 14, wherein the display of the patient's medication adherence patterns groups the one or more of the medications the patient is prescribed by class of medication.

19. The system of claim 14, wherein the display of the patient's medication adherence patterns includes overutilized medications, underutilized medications, previous recognized barriers to adherence, intervention strategies, adherence by disease state, and overall adherence rate.

20. The system of claim 14, wherein the percentage of days covered is calculated by dividing the number of days covered by the number of eligible days.
